(19) United States
(12) Patent Application Publication
(10) Pub. No.: US 2026/0059397 A1
(43) Pub. Date: Feb. 26, 2026

(54) SEPARATION OF INTER-CELL HANDOVER AND CONTEXT TRANSFER

(71) Applicant: QUALCOMM Incorporated, San Diego, CA (US)

(72) Inventors: Karl Georg HAMPEL, Jersey City, NJ (US); Shankar KRISHNAN, Poway, CA (US); Naeem AKL, Bridgewater, NJ (US); Prasada Veera Reddy KADIRI, San Diego, CA (US); Gavin Bernard HORN, La Jolla, CA (US); Ozcan OZTURK, San Diego, CA (US)

(21) Appl. No.: 18/815,682

(22) Filed: Aug. 26, 2024

(51) Int. Cl. H04W 36/00; H04W 60/04; H04W 76/20

(52) U.S. Cl. CPC H04W 36/0061; H04W 36/0033; H04W 36/0072; H04W 60/04; H04W 76/20

(57) ABSTRACT

Certain aspects of the present disclosure provide techniques for separation of inter-cell handover and context transfer. An example method for wireless communications by a first network entity includes obtaining, from a first user equipment, a first request to establish a first communication link between the first user equipment and a second network entity; transmitting a second request for a first address of the second network entity; obtaining an indication of the first address of the second network entity; transmitting, to the second network entity at the first address, the first request; and forwarding communications associated with the first communication link between the first user equipment and the second network entity.

### INTRODUCTION

### Field of the Disclosure

Aspects of the present disclosure relate to wireless communications, and more particularly, to techniques for separation of inter-cell handover and context transfer.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, or the like. Consequently, there exists a need for further improvements in wireless communications systems to overcome the aforementioned technical challenges and others.

### SUMMARY

One aspect provides a method for wireless communications by a first network entity. The method includes obtaining, from a first user equipment, a first request to establish a first communication link between the first user equipment and a second network entity; transmitting a second request for a first address of the second network entity; obtaining an indication of the first address of the second network entity; transmitting, to the second network entity at the first address, the first request; and forwarding communications associated with the first communication link between the first user equipment and the second network entity.

Another aspect provides a method for wireless communications by a first network entity. The method includes communicating with a first user equipment via a second network entity; transmitting a first request for a first address of a third network entity associated with a first cell; obtaining an indication of the first address of the third network entity; transmitting, to the third network entity at the first address, a second request to setup user equipment context associated with the first user equipment; obtaining, from the third network entity, a response that confirms setup of the user equipment context associated with the first user equipment; transmitting, to the second network entity, an indication to handover communications with the first user equipment to the third network entity; and communicating with the first user equipment via the third network entity.

Another aspect provides a method for wireless communications by an apparatus. The method includes transmitting, to a first network entity via a first cell, a random access message that includes a request to establish a communication link with a second network entity; and communicating with the second network entity via the first cell served by the first network entity.

Another aspect provides a first network entity configured for wireless communications. The first network entity includes one or more memories and one or more processors coupled to the one or more memories. The one or more processors are configured to cause the first network entity to obtain, from a first user equipment, a first request to establish a first communication link between the first user equipment and a second network entity; transmit a second request for a first address of the second network entity; obtain an indication of the first address of the second network entity; transmit, to the second network entity at the first address, the first request; and forward communications associated with the first communication link between the first user equipment and the second network entity.

Another aspect provides a first network entity configured for wireless communications. The first network entity includes one or more memories and one or more processors coupled to the one or more memories. The one or more processors are configured to cause the first network entity to communicate with a first user equipment via a second network entity; transmit a first request for a first address of a third network entity associated with a first cell; obtain an indication of the first address of the third network entity; transmit, to the third network entity at the first address, a second request to setup user equipment context associated with the first user equipment; obtain, from the third network entity, a response that confirms setup of the user equipment context associated with the first user equipment; transmit, to the second network entity, an indication to handover communications with the first user equipment to the third network entity; and communicate with the first user equipment via the third network entity.

Another aspect provide an apparatus configured for wireless communications. The apparatus includes one or more memories and one or more processors coupled to the one or more memories, the one or more processors being configured to cause the apparatus to transmit, to a first network entity via a first cell, a random access message that includes a request to establish a communication link with a second network entity; and communicate with the second network entity via the first cell served by the first network entity.

Another aspect provides a first network entity configured for wireless communications. The first network entity includes means for obtaining, from a first user equipment, a first request to establish a first communication link between the first user equipment and a second network entity; means for transmitting a second request for a first address of the second network entity; means for obtaining an indication of the first address of the second network entity; transmitting, to the second network entity at the first address, the first request; and means for forwarding communications associated with the first communication link between the first user equipment and the second network entity.

Another aspect provides a first network entity configured for wireless communications. The first network entity includes means for communicating with a first user equipment via a second network entity; transmitting a first request for a first address of a third network entity associated with a first cell; means for obtaining an indication of the first address of the third network entity; means for transmitting, to the third network entity at the first address, a second request to setup user equipment context associated with the first user equipment; means for obtaining, from the third network entity, a response that confirms setup of the user equipment context associated with the first user equipment; means for transmitting, to the second network entity, an indication to handover communications with the first user equipment to the third network entity; and means for communicating with the first user equipment via the third network entity.

Another aspect provides an apparatus configured for wireless communications. The method includes transmitting, to a first network entity via a first cell, a random access message that includes a request to establish a communication link with a second network entity; and communicating with the second network entity via the first cell served by the first network entity.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example of UE mobility in a wireless communications network.

FIG. 6A depicts an example scheme of an anchored centralized unit (CU) for inter-distributed unit (DU) handover.

FIG. 6B depicts an example scheme for UE context transfer from a source network entity to a target network entity with respect to FIG. 6A.

FIG. 7 depicts a process flow for signaling related to anchored CU and inter-DU handover or cell switch.

FIG. 8 depicts a process flow for signaling related to inter-CU context transfer.

FIG. 9 depicts another process flow for signaling related to CU registration and CU selection.

FIG. 10 depicts a method for wireless communications.

FIG. 11 depicts another method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for separation of inter-cell handover and context transfer.

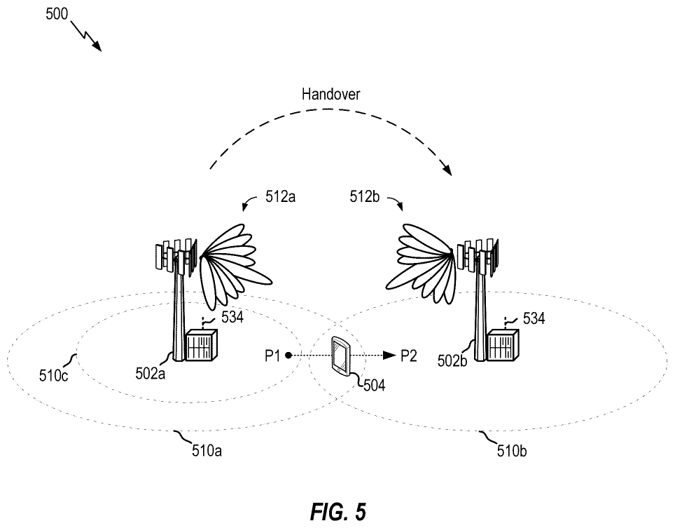

Mobility management is a scheme employed to ensure service-continuity of a user equipment (UE) through handovers and/or beam switching during UE mobility, for example, as the UE moves across different coverage areas of a radio access network (RAN). During a handover, a source network entity (e.g., a base station) transfers a connection with a UE to a target network entity, which may be or include a neighboring network entity, for example, as further described herein with respect to FIG. 5. A neighboring network entity may communicate via candidate cell(s) and/or beam(s) having a coverage area adjacent to or overlapping with the coverage area of the source network entity. As the coverage area of a single network entity decreases, such as for high-frequency communications (e.g., millimeter-wave (mmWave) or sub-terahertz communications), the frequency for a UE to handover between network entities becomes high, especially for a high-mobility UE (e.g., a UE traveling in a vehicle). In addition, for applications (e.g., extended reality and/or cloud gaming) characterized with stringent performance specifications (e.g., quality of service (QoS) parameters such as reliability, latency, etc.), the quality of experience may be sensitive to the handover performance, such as unsuccessful handovers. An unsuccessful handover can cause packet losses and/or extra delay during the mobility period, which can cause QoS specifications to not be met for packet-drop-intolerant and low-latency applications.

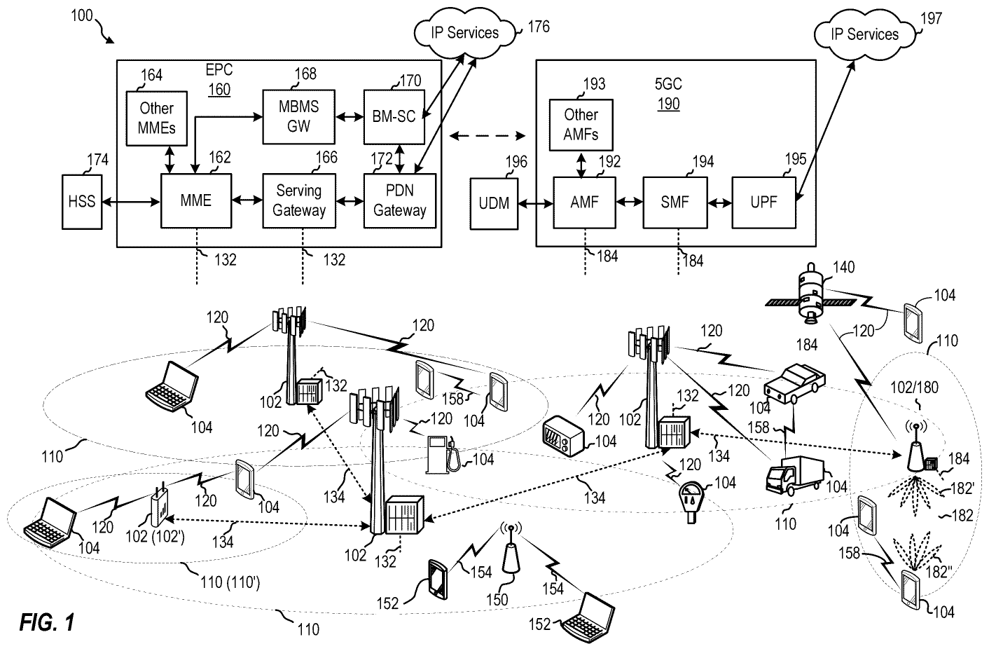

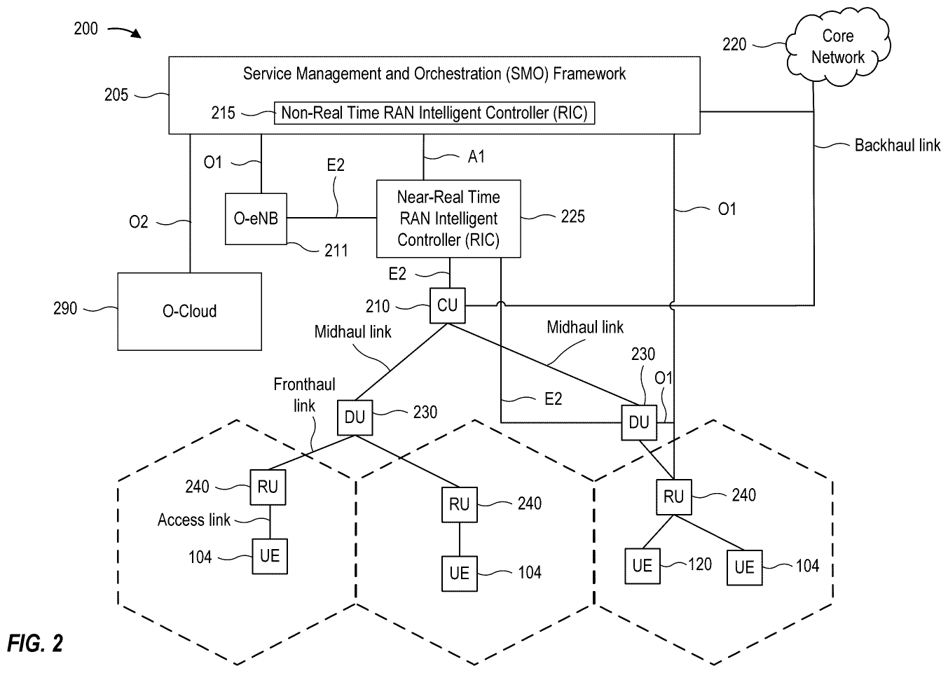

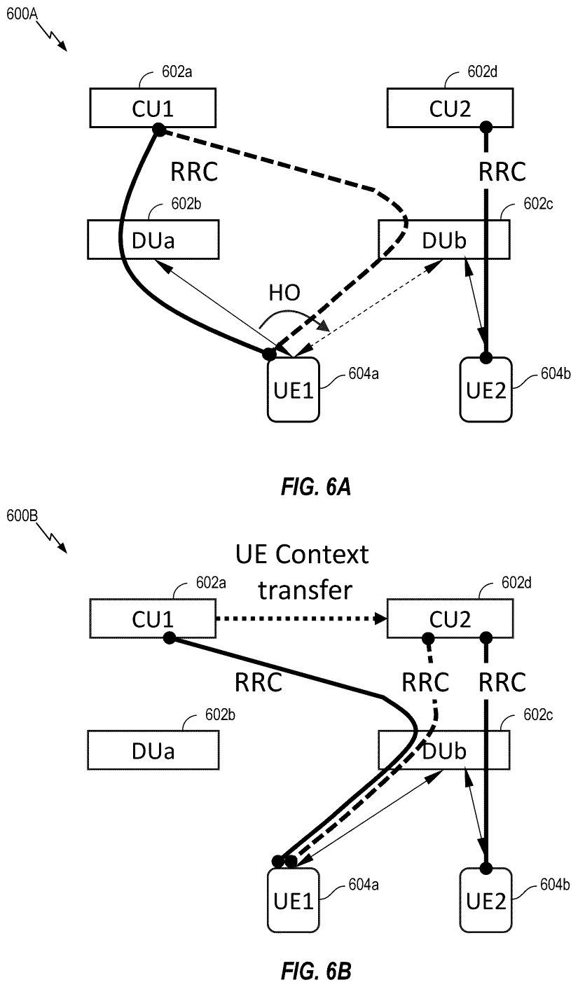

Technical problems for mobility management may include, for example, providing effective procedures for inter-network entity mobility. Certain wireless communications systems (e.g., 5G NR systems) may employ a disaggregated architecture of a base station, which may include a distributed unit (DU) and a centralized unit (CU), for example, as further described herein with respect to FIGS. 1 and 2. In certain cases, a DU may only be allowed to communicate with a single CU. When a UE moves between the coverage areas of DUs connected to different CUs, a source CU (which is connected to the source DU) may transfer the UE context associated with the UE to a target CU (which is connected to the target DU). The UE context may be or include information associated with the control plane traffic session and/or user plane traffic session of the UE, for example, as further described herein with respect to FIG. 6. Such an inter-CU handover may involve a non-trivial amount of signaling overhead and/or latency, for example, due in part to the UE context transfer between CUs. Moreover, the latency and/or signaling overhead associated with the inter-CU handover may occur frequently when the UE ping-pongs between the coverage areas of the DUs.

Aspects described herein may overcome the aforementioned technical problem(s), for example, by providing schemes for separation of inter-cell handover and context transfer. An inter-cell handover may involve an inter-DU handover. Context transfer may refer to transferring UE context information, associated with a UE and stored at one network entity (e.g., a source CU), to another network entity (e.g., a target CU). In certain aspects, a user plane session and/or control plane session of a UE may be anchored at a CU during an inter-DU handover. As an example, the UE context associated with the UE may remain at the serving CU during the inter-DU handover. In certain aspects, a DU may be connected to multiple CUs, concurrently. As an example, the DU may support communications with UEs having user plane and/or control plane sessions managed by different CUs. In certain aspects, the anchored CU for inter-DU handover may enable specialization of the CU for certain service(s) or UE capabilities. For example, the CU may be dedicated to managing the user plane session and/or control plane session for certain service(s) and/or UE capabilities, such as narrowband traffic of internet-of-things (IoT) devices, ultra-reliable low latency (URLLC) traffic, enhanced mobile broadband traffic, or the like. In certain aspects, the anchored CU for inter-DU handover may enable service-based interfaces for inter-network entity communications.

Certain techniques for separation of inter-cell handover and context transfer described herein may provide various beneficial technical effects and/or advantages. The techniques for separation of inter-cell handover and context transfer may enable improved wireless communications performance, such as reduced signaling, latencies, interruption times, packet losses, handover failures, and/or ping-ponging between network entities. The improved performance (such as reduced signaling and/or latencies) may be attributable to the user plane session and/or control plane session of a UE being anchored at a CU during an inter-DU handover. For example, the serving CU may maintain the user plane session and/or control plane session of the UE during the inter-DU handover without a UE context transfer to another CU. In certain cases, the reduced latency may be attributable to certain tunnels (e.g., tunnels to a CU-user plane) for a user plane session of the UE being retained during a UE context transfer.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

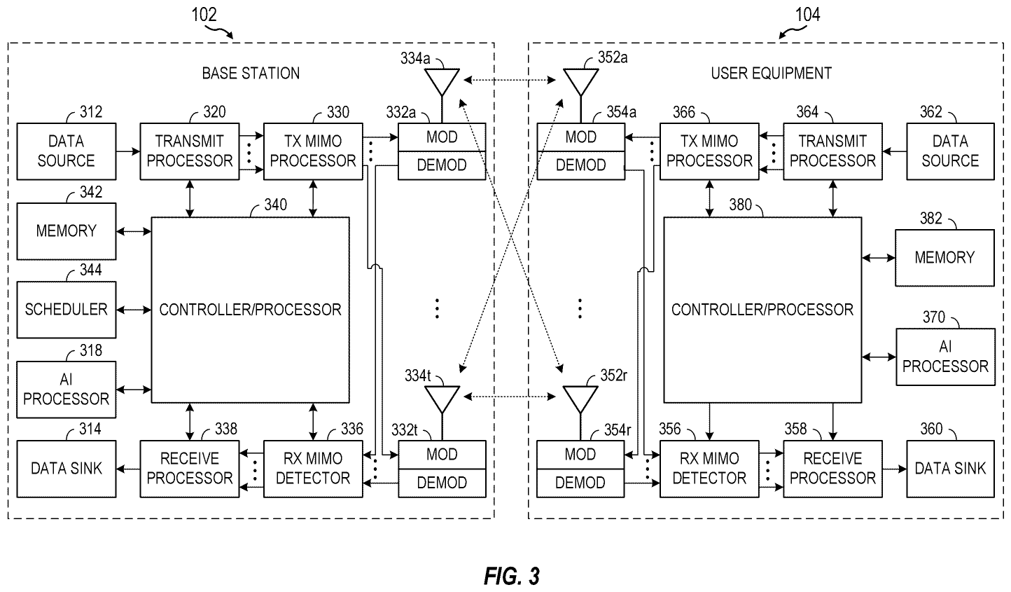

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

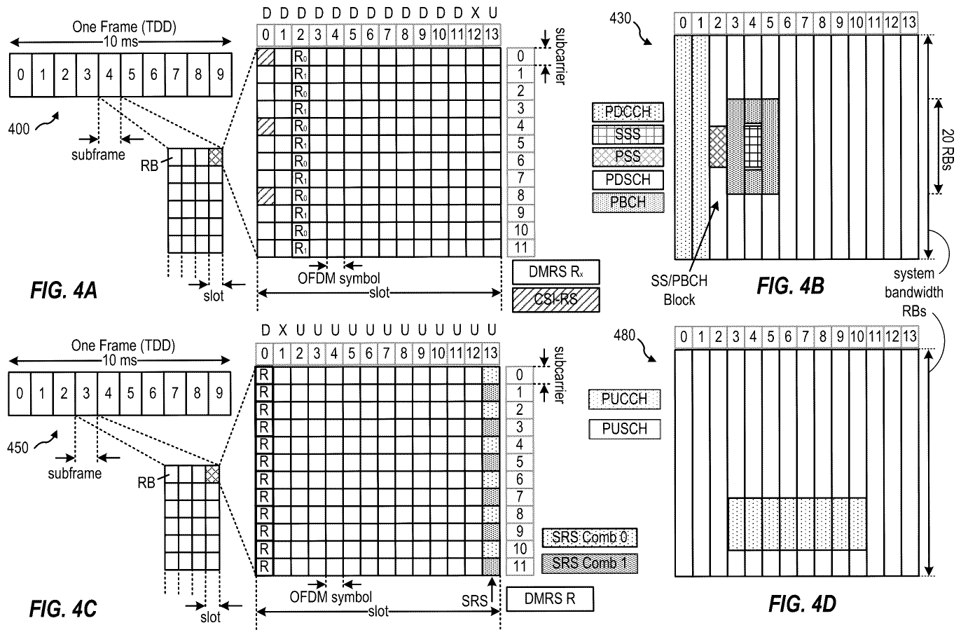

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL. Wireless communications frame structures may also be time division duplex (TDD), in which, for a particular set of subcarriers, subframes within the set of subcarriers are dedicated for either DL or UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Mobility Management

FIG. 5 depicts an example of UE mobility in a wireless communications network 500. In this example, the wireless communications network 500 may include a first network entity 502a having a first coverage area 510a and a second network entity 502b having a second coverage area 510b, which may overlap with or be adjacent to the first coverage area 510a. The first network entity 502a may also have a third coverage area 510c. In certain aspects, the first coverage area 510a may form a first cell, the second coverage area 510b may form a second cell, and the third coverage area 510c may form a third cell. The first cell and third cell may form a first cell group, and the second cell may form a second cell group. The first network entity 502a may communicate via a first set of beams 512a, and the second network entity 502b may communicate via a second set of beams 512b.

Due to mobility (e.g., a UE 504 moving from the first coverage area 510a to the second coverage area 510b), the UE 504 may transition from communicating with the first network entity 502a via the first set of beams 512a to communicating with the second network entity 502b via the second set of beams 512b. As an example, the UE 504 may be located at a first position P1 in the first coverage area 510a and/or the third coverage area 510c at a first occasion, and then the UE 504 may move to a second position P2 in the second coverage area 510b at a second, later occasion.

In some cases, the UE 504 may transmit a measurement report to the first network entity 502a. For example, the first network entity 502a may configure the UE 504 to measure a set of neighboring cell(s) and/or beam(s) of one or more neighboring network entities (e.g., the second network entity 502b). In some cases, the UE 504 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 502a. As an example, the neighboring cell(s) and/or beam(s) may include the second cell of the second coverage area 510b and/or the second set of beams 512b. The measurement report may indicate radio measurements (e.g., signal strengths) associated with the serving cell of the first network entity 502a and/or neighboring cell(s), such as the cell(s) of the second network entity 502b. In certain cases, the measurement report may indicate the signal strengths associated with certain beam(s) of the serving cell and the neighboring cell(s), such as the first set of beams 512a and/or the second set of beams 512b. Based on the measurement report (e.g., indicating a stronger signal strength associated with radio measurements for the second network entity 502b relative to the first network entity 502a), the first network entity 502a may determine to handover (HO) communications with the UE 504 to the second network entity 502b. The first network entity 502a may be in communication with the second network entity 502b via a backhaul link 534 (e.g., an F1, Xn, and/or NG interface) in order to exchange information for the handover.

In the context of a handover or mobility operation, the first network entity 502a may be referred to as a source network entity; and the second network entity 502b may be referred to as a target, candidate, neighbor, or neighboring network entity, depending on the stage of the handover or mobility operation. As part of a handover, the source network entity transfers a connection with a UE to a target network entity. A candidate or neighboring network entity may be a possible target for the handover, and in some cases, the candidate or neighboring network entity may communicate via candidate cell(s) and/or beam(s) having coverage area(s) adjacent to or overlapping with the coverage area(s) of the source network entity.

In some cases, the handover may involve a CU/DU handover, such as inter-DU-intra-CU handover and/or inter-CU handover. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 502a and/or the second network entity 502b may be an example of an RU, DU, and/or CU.

Note that the handover illustrated in FIG. 5 is an example of a mobility operation. Aspects of the present disclosure described herein may be applied to various types of UE mobility operations including, for example, (conditional) lower-layer triggered mobility (LTM), L3 mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., certain QoS specification(s) for communications are satisfied).

### Aspects Related to Separation of Inter-Cell Handover and Context Transfer

Aspects of the present disclosure provide certain techniques for separation of inter-cell handover and context transfer, for example, via anchored CU, inter-DU handover. The techniques for separation of inter-cell handover and context transfer may enable reduced signaling, latencies, interruption times, packet losses, handover failures, and/or ping-ponging between network entities.

FIG. 6A depicts an example scheme 600A of an anchored CU for inter-DU handover. In this example, a first UE 604a may be in communication with a first network entity 602a (e.g., a CU depicted as “CU1”) via a first cell served at or by a second network entity 602b (e.g., a DU depicted as “DUa”). Then, as part of an inter-DU handover (further described herein), the first UE 604a may be in communication with the first network entity 602a via a second cell served at or by a third network entity 602c (e.g., a DU depicted as “DUb”). When the first UE 604a is communicating via the first cell (e.g., before the inter-DU handover), the second cell may be a possible candidate cell to which the first UE 604a can handover for communications. Thus, with respect to the first UE 604a, the second network entity 602b may be a source network entity, and the third network entity 602c may be a target, neighboring, and/or candidate network entity as described herein with respect to FIG. 5. The first cell may be an example of a cell formed by the first coverage area 510a of FIG. 5, and the second cell may be an example of another cell formed by the second coverage area 510b of FIG. 5.

Any of the network entities 602a-d may be or include a disaggregated network entity of a base station, for example, as described herein with respect to FIG. 2. As an example, the first network entity 602a and the second network entity 602b may form a first disaggregated base station (or one or more entities thereof); and the first network entity 602a and the third network entity 602c may form a second disaggregated base station (or one or more entities thereof); and a fourth network entity 602d and the third network entity 602c may form a third disaggregated base station (or one or more entities thereof).

At a first phase (e.g., a connection establishment phase), the first UE 604a may establish a control plane traffic session (e.g., an RRC connection and/or signaling radio bearer(s) for the RRC connection) and/or a user plane traffic session (e.g., a protocol data unit (PDU) session and/or data radio bearer(s) for the PDU session) with the first network entity 602a via the first cell served at or by the second network entity 602b. A control plane traffic session may refer to a control signaling connection for a UE (such as an RRC connection and/or signaling radio bearer(s)) to communicate control plane traffic, and a user plane traffic session may refer to a data traffic connection for the UE (such as a PDU session and/or data radio bearer(s)) to communicate user plane traffic. In certain cases, the first UE 604a may transmit, to the second network entity 602b via the first cell, a request to establish a communication link (e.g., a control plane traffic session and/or a user plane traffic session) with the first network entity 602a. The first UE 604a may request a CU for management of the user plane traffic session and/or control plane traffic session. In a request for connection establishment (or connection setup, communication link establishment, or the like), the first UE 604a may provide an indication of the first network entity 602a, such as an identifier (or address) associated with the first network entity 602a. The identifier may be or include a CU identifier or identity (CU-ID), which may be unique to a particular CU. As an example, the first UE 604a may transmit a random access message (such as MSG3 or a RRC connection setup request) that indicates or includes the CU-ID of a candidate CU for management of the user plane traffic session and/or control plane traffic session. In certain cases, the first UE 604a may transmit an indication of the CU-ID of a candidate CU in or via certain signaling, such as a random access message, medium access control (MAC) signaling, radio resource control (RRC) signaling (e.g., a RRC setup request, RRC resume request, RRC reestablishment request, etc.), and/or the like. In certain cases, the indication of the CU-ID may be included in a request to establish a communication link with the network entity associated with the CU-ID.

The identifier associated with the first network entity 602a may be or include a location of the first network entity 602a, internet protocol (IP) address of the first network entity 602a, a domain name (e.g., a fully qualified domain name (FQDN)) of the first network entity 602a, an indicator of a service type, and/or the like. The service type indicator may correspond to a service managed by the first network entity 602a, for example, for service-based network slicing and/or service based interfaces or application programming interfaces (APIs).

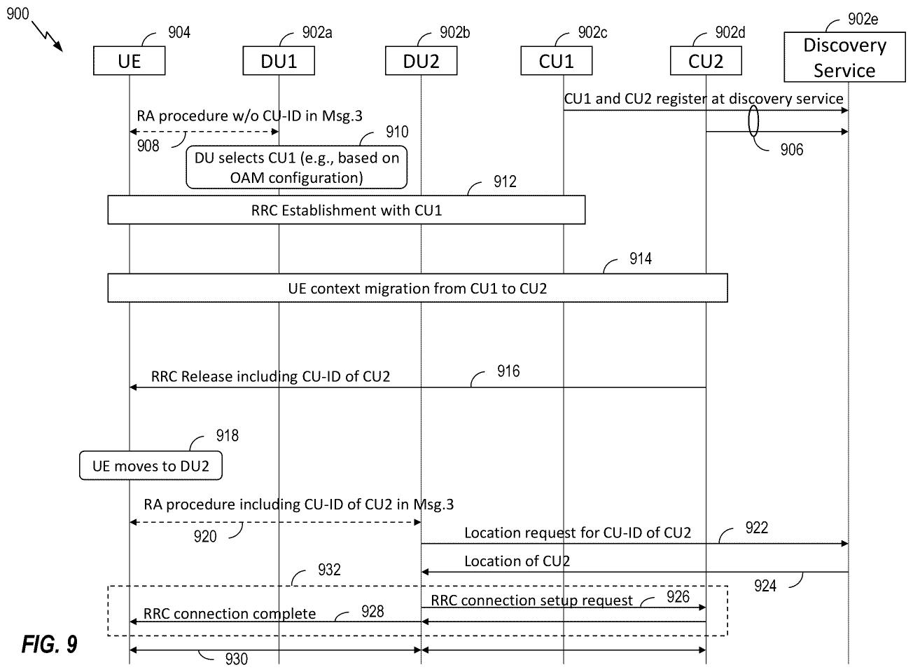

In certain cases, the first UE 604a may obtain the identifier associated with the first network entity 602a via signaling from any of the network entities 602a-d as further described herein with respect to FIG. 9. As an example, the first UE 604a may obtain the identifier associated with the first network entity 602a upon a connection release with the first network entity 602a (for example, related to a previous connection with the first network entity 602a). In certain aspects, the first UE 604a may obtain the identifier associated with the first network entity 602a via an RRC connection configuration. In certain aspects, the first UE 604a may obtain a time window and/or a geographical area (e.g., a set of cells, a tracking area, a set of network entity identifier, a PLMN, and/or the like) for which a candidate CU is valid or available for indication in a request to establish a communication link with the candidate CU, for example, when the first UE 604a performs a random access procedure. The first UE 604a may store the identifier associated with the first network entity 602a for subsequent connection establishment(s), for example, performed at the first phase discussed herein.

In certain aspects, the first network entity 602a may register with a discovery service as further described herein with respect to FIG. 9. The discovery service may be or include a domain name system (DNS), a network repository function (NRF), cell control function, cell data repository, and/or the like. The discovery service may be hosted by any of the network entities 602a-b or any other suitable network entity, such as an entity of a core network (e.g., the NRF). In certain aspects, a discovery service network entity may refer to a network entity (e.g., a virtual server or a dedicated physical server) that hosts or serves a discovery service, such as a DNS, NRF, cell control function, cell data repository, and/or the like. The registration of the first network entity 602a with the discovery service may enable the second network entity 602b to discover the first network entity 602a as a managing or serving CU for connection establishment, for example, based on the identifier associated with the first network entity 602a provided by the first UE 604a.

In certain cases, the request for connection establishment from the first UE 604a may not specify a managing or serving CU for connection establishment. The second network entity 602b may select the first network entity 602a as the managing CU for connection establishment, for example, based on an operations, administration, and management (OAM) configuration, one or more policies, and/or pre-configuration. In certain cases, the CU selection at the DU may be initiated by a CU, for example, based on a handover preparation request or LTM candidate cell preparation request received from the CU. Accordingly, CU selection at the DU may be based on a configuration, policy, and/or information obtained from one or more network entities, such as candidate CU(s).

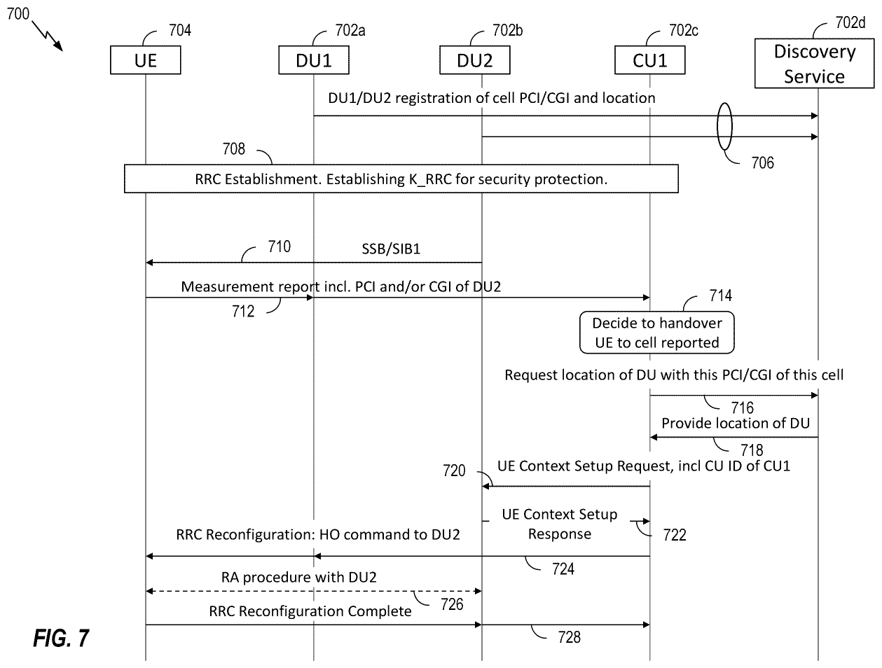

In certain aspects, the second network entity 602b may register with the discovery service as further described herein with respect to FIG. 7. The registration of the second network entity 602b with the discovery service may enable the first network entity 602a to discover the second network entity 602b as a target network entity for a handover (e.g., an inter-DU handover). The first network entity 602a may determine that the third network entity 602c serves a candidate cell with respect to the communication link between the first network entity 602a and the first UE 604a. In certain cases, the first network entity 602a may be configured with a set of candidate cells associated with the first cell, for example, via one or more mobility management configurations (e.g., LTM configurations, AI-aided mobility management configurations, or the like) exchanged among the network entities 602a-d.

In certain cases, the first network entity 602a may obtain an indication that the second cell is a candidate cell for the first UE 604a, for example, via a measurement report. As an example, the first network entity 602a may obtain an indication of the second cell in a measurement report from the first UE 604a. The second network entity 602b may obtain, from the first UE 604a, the measurement report, which may include measurement(s) associated with the second cell; and the second network entity 602b may forward the measurement report to the first network entity 602a. Then, based on the measurement report, the first network entity 602a may discover, from the discovery service, an identifier associated with the second network entity 602b (e.g., an address, domain name, location, or the like) based on a cell identifier associated with the second cell, such as a physical cell identifier (PCI) or a cell global identity (CGI). The identifier may be or include a DU identifier or identity (DU-ID), which may be unique to a particular DU.

At a second phase (e.g., a handover or cell switch phase), the first UE 604a may perform a cell switch from the first cell to the second cell, for example, as further described herein with respect to FIG. 7. The second phase may occur after the first phase. The first UE 604a may switch from communicating with the first network entity 602a via the first cell to communicating via the second cell through the third network entity 602c, for example, in response to a cell switch command, handover command, and/or the like. The first UE 604a may communicate with the first network entity 602a via the second cell served by or at the third network entity 602c while using the control plane traffic session and/or the user plane traffic session established with the first network entity 602a. As an example, the first UE 604a may communicate with the third network entity 602c via the second cell based on the RRC connection and/or PDU session established with the first network entity 602a. The control plane traffic session and/or the user plane traffic session being anchored at the first network entity 602a may enable reduced latencies, interruption times, and/or signaling overhead when the first UE 604a switches to communicating via the second cell served by or at the third network entity 602c.

In some cases, a second UE 604b may be in communication with the fourth network entity 602d (e.g., a CU depicted as “CU2”) via the second cell served at or by the third network entity 602c. For example, the third network entity 602c may obtain, from the second UE 604b, a request to establish a communication link (for example, with the fourth network entity 602d). In certain cases, the request for connection establishment from the second UE 604b may not specify a managing or serving CU for connection establishment, for example, as discussed above. After establishing the communication link, the third network entity 602c may forward communications associated with the communication link between the second UE 604b and the fourth network entity 602d. Accordingly, the third network entity 602c may be in communication with multiple CUs, such as the first network entity 602a and the fourth network entity 602d, and multiple UEs, such as the first UE 604a and the second UE 604b.

The third network entity 602c may communicate with the first UE 604a and the second UE 604b via the same cell, such as the second cell, and/or different cells, as further discussed herein. The third network entity 602c may support forwarding traffic for user plane and/or control plane traffic session(s) (e.g., data radio bearer(s) and/or signaling radio bearer(s)) managed by multiple CUs, such as the first network entity 602a and the fourth network entity 602d. In certain cases, the signaling (e.g., RRC signaling) between the DU and CUs may be based on a point-to-point interface or based on a service-based interface. In certain cases, the first cell served at or by the second network entity 602b and the second cell served at or by the third network entity 602c may be part of the same wireless communications system, such as a public land mobile network (PLMN). Similarly, the network entities 602a-d may be part of the same wireless communications system or PLMN.

FIG. 6B depicts an example scheme 600B for UE context transfer from a source network entity to a target network entity with respect to scheme 600A of FIG. 6A. In this example, the first UE 604a may have performed a cell switch to the second cell with the management of the control plane traffic session and/or user plane traffic session of the first UE 604a being anchored at the first network entity 602a, for example, as described herein with respect to FIG. 6A. Alternatively or additionally, the first UE 604a may have established a communication link with the first network entity 602a via the second cell served by or at the third network entity 602c, for example, without a handover or cell switch. As an example, the first UE 604a may transmit a request, to the third network entity 602c via the second cell, to establish a communication link with the first network entity 602a.

In certain aspects, the first network entity 602a may transfer management of the control plane traffic session and/or user plane traffic session of the first UE 604a to the fourth network entity 602d while the second cell remains the serving cell for the first UE 604a. In certain cases, the inter-CU UE context transfer may be triggered after successful completion of an inter-DU handover (for example, as described herein with respect to FIG. 6A), In certain cases, the inter-CU UE context transfer may be triggered after completion of radio link failure (RLF) recovery, for example, triggered by a cell failure with respect to the first cell. In certain cases, the inter-CU UE context transfer may be based on the capabilities of the target CU (e.g., transport latency, transport bandwidth, traffic load, or the like), and the source CU may obtain the capabilities of a candidate CU from the discovery service.

The first network entity 602a may transfer, to the fourth network entity 602d, UE context associated with the first UE 604a. The UE context may be or include information associated with the control plane traffic session and/or user plane traffic session of the first UE 604a. The UE context may be or include one or more parameters for one or more signaling radio bearers, one or more data radio bearers, a backhaul RLC channel, and/or the like. As an example, the first network entity 602a may transmit, to the fourth network entity 602d, a request to transfer the UE context associated with the first UE 604a. The request to transfer the UE context may indicate or include an indication of the serving DU for the first UE 604a, such as the third network entity 602c. The indication of the serving DU may be or include an identifier associated with the serving DU (e.g., DU-ID), such as an address of the DU, location of the DU, or the like.

The indication of the serving DU may allow the target CU to initiate a reconfiguration of the control plane session via the serving DU. For example, based on the indication of the serving DU, the target CU may transmit, to the serving DU, an RRC reconfiguration message, for example, with an updated security algorithm configuration. The serving DU may transmit, to the UE, the RRC reconfiguration message. The security algorithm configuration may indicate or include a security key and/or security algorithm (e.g., a ciphering algorithm and/or integrity protection algorithm) to be used for radio bearer(s).

In certain aspects, the first network entity 602a may transfer management of the control plane traffic session and/or user plane traffic session of the first UE 604a to the fourth network entity 602d based at least in part on one or more criteria. In certain cases, the inter-CU UE context transfer may be triggered based on a transport latency, such as the transport latency between the source CU and serving DU (e.g., the first network entity 602a and the third network entity 602c) and/or the expected transport latency between the target CU and the serving DU (e.g., the fourth network entity 602d and the third network entity 602c). As an example, when the transport latency between the source CU and serving DU is above a threshold latency, the first network entity 602a may transfer management of the control plane traffic session and/or user plane traffic session of the first UE 604a to the fourth network entity 602d. As another example, when the transport latency between the target CU and serving DU is expected to improve by a threshold, the first network entity 602a may transfer management of the control plane traffic session and/or user plane traffic session of the first UE 604a to the fourth network entity 602d.

In certain cases, the inter-CU UE context transfer may be triggered based at least in part on processing and/or traffic load levels associated with the source network entity (e.g., the first network entity 602a) and/or the target network entity (e.g., the fourth network entity 602d). The inter-CU UE context transfer may be triggered for CU load balancing of processing resources (e.g., memory and/or computational resources) to prevent overloading at the first network entity 602a and/or the fourth network entity 602d. For example, the first network entity 602a may be (or expected to be) overloaded with UE traffic sessions, and the first network entity 602a may transfer the UE context to the fourth network entity 602d to offload the processing and/or traffic associated with communications with the first UE 604. As an example, when the processing, memory, and/or traffic utilization is above a threshold, the first network entity 602a may transfer the UE context to the fourth network entity 602d.

In certain cases, the inter-CU UE context transfer may be triggered based at least in part on certain service(s) or traffic being communicated (or expected to be communicated) with the first UE 604, for example, for network slicing of services. As an example, the fourth network entity 602d may be dedicated to managing certain service(s) or traffic (such as mobile edge computing (MEC), URLLC traffic, gaming traffic, extended reality (XR) traffic, and/or the like). When the first UE 604 communicates (or is expected to communicate) certain traffic served or managed by or at the fourth network entity 602d, the first network entity 602a may transfer the UE context associated with the first UE 604 to the fourth network entity 602d.

In certain cases, the inter-CU UE context transfer may be triggered based at least in part on one or more policies (e.g., a network operator configured policy), OAM configuration(s), and/or the like. A policy may be or include a UE mobility policy (e.g., location-based policy), a QoS policy or specification, or the like. In certain aspects, the policy may define the criteria for CU selection for UE context transfer. In certain aspects, the policy may define the criteria for initiation or triggering the UE context transfer.

In certain aspects, the control plane session may be transferred to the target network entity, while the user plane session may be anchored at the source network entity, or vice versa. As an example, the first network entity 602a may retain management of the user plane session associated with the first UE 604 for the inter-CU UE context transfer to the fourth network entity 602d. The UE context may indicate or include an identifier associated with a CU user plane (CU-UP), such as a CU-UP of the first network entity 602a. The CU-UP may be or include a user plane function (UPF) that manages the user plane session(s) of one or more UEs. The first network entity 602a may transmit, to the fourth network entity 602d, the UE context associated with the first UE 604 for the inter-CU UE context transfer. The target CU control plane (CU-CP), such as the fourth network entity 602d, may transmit, to the source CU-UP, an acknowledgement or notification to indicate the fourth network entity 602d is the serving CU-CP for the control plane traffic with the first UE 604. The acknowledgement or notification may indicate or include the UE ID, a CU-CP ID, and/or a request to forward load-related, activity-related, or other information for the UE. This acknowledgement or notification may allow the serving CU-UP (e.g., the first network entity 602a) to know which CU-CP (e.g., the fourth network entity 602d) with which to communicate for managing the traffic load, UE configuration, or the like. In certain aspects, a CU may be or include a CU-CP, a CU-UP, a service (such as a UE connection service or a UE mobility service), and/or mobility function.

### Example Signaling Related to Separation of Inter-Cell Handover and Context Transfer

FIG. 7 depicts a process flow 700 for signaling related to anchored CU and inter-DU handover or cell switch in a system including network entities 702a-d and a user equipment (UE) 704. In some aspects, any of the network entities 702a-d may be an example of the BS 102 depicted and described with respect to FIGS. 1 and 3 or a disaggregated base station (or one or more entities thereof) depicted and described with respect to FIG. 2. As an example, each of the first network entity 702a and the second network entity 702b may be an example of a DU (depicted as “DU1” and “DU2”, respectively), and the third network entity 720c may be an example of a CU (depicted as “CU1”). The fourth network entity 702d may be an example of a discovery service network entity (depicted as “Discovery Service”), which may host or serve a discovery service as described herein. Similarly, the UE 704 may be an example of UE 104 depicted and described with respect to FIGS. 1 and 3. However, in other aspects, UE 704 may be another type of wireless communications device and any of the network entities 702a-d may be another type of network entity or network node, such as those described herein. Note that any operations or signaling illustrated with dashed lines may indicate that that operation or signaling is an optional or alternative example.

At 706, each of the first network entity 702a and the second network entity 702b transmits, to the fourth network entity 702d, registration information associated with the respective network entity 702a, 702b. The registration information may include an indication of one or more cell identifiers associated with one or more cells served by the respective network entity and/or an indication of an address of the respective network entity. The registration information may enable the third network entity 702c to identify a target network entity, for example, for inter-DU handover.

At 708, the UE 704 establishes an RRC connection with the third network entity 702c via the first network entity 702a. For example, the UE 704 may transmit, to the first network entity 702a via a first cell, an RRC connection setup request; and the first network entity 702a may transmit, to the third network entity 702c, the RRC connection setup request. The third network entity 702c may transmit, to the UE 704 via the first network entity 702a, an RRC connection setup message.

At 710, the UE 704 obtains, from the second network entity 702b, one or more reference signals. The reference signal(s) may include, for example, SSB(s), CSI-RS(s), DMRS(s), or the like. In certain cases, the UE 704 obtains, from the second network entity 702b, system information (e.g., a SIB) that indicates the candidate cell(s) served at or by the second network entity 702b.

At 712, the UE 704 transmits, to the first network entity 702a, a measurement report that indicates or includes one or more radio measurements associated with the candidate cell(s) served at or by the second network entity 702b. The first network entity 702a may transmit the measurement report to the third network entity 702c. The measurement report may indicate or include a cell identifiers associated with each of the candidate cell(s) and/or radio measurement(s) associated with each of the candidate cell(s).

At 714, the third network entity 702c determines to perform a handover of the UE to a candidate cell. The third network entity 702c may determine to perform a cell switch from the serving cell of the first network entity 702a to the candidate cell of the second network entity 702b, for example, an anchored CU, inter-DU handover as described herein with respect to FIG. 6A. In certain aspects, the third network entity 702c may select the candidate cell based on the measurement report obtained at 712, such as a cell served at or by the second network entity 702b. In certain cases, the third network entity 702c may select the candidate cell based at least in part on other suitable criteria, such as load balancing, QoS specifications, or the like. Accordingly, the control plane traffic session and/or the user plane traffic session of the UE 704 may be anchored at third network entity 702c. Such UE session anchoring at the third network entity 702c may enable reduced latencies, interruption times, and/or signaling overhead when the UE 704 switches to communicating via the candidate cell served at or by the second network entity 702b.

At 716, the third network entity 702c transmits, to the fourth network entity 702d, a request for an address or location of the second network entity 702b, for example, based on a cell identifier (e.g., a PCI and/or CGI) associated with the candidate cell served at or by the second network entity 702b. The address may be or include an IP address of the second network entity 702b, a domain name of the second network entity 702b, an indicator of a service type of the second network entity 702b, and/or the like. The fourth network entity 702d may be aware of the association between a cell identifier and an address or location of a network entity based on the registration information shared at 706.

At 718, the third network entity 702c obtains, from the fourth network entity 702d, an indication of the address or location of the second network entity 702b.

At 720, the third network entity 702c transmits, to the second network entity 702b at the discovered address, a request to establish a communication link between the UE 704 and the second network entity 702b. As an example, the third network entity 702c may transmit, to the second network entity 702b, a UE context setup request that includes a CU identifier (CU-ID) of the third network entity 702c.

At 722, the second network entity 702b transmits, to the third network entity 702c, a response to the request, such as a UE context setup response. The UE context setup response may indicate or include a cell group configuration for the UE 704 to communicate with the cell(s) served at or by the second network entity 702b.

At 724, the third network entity 702c transmits, to the first network entity 702a, an indication to handover communications with the UE to the second network entity 702b. For example, the third network entity 702c may transmit an RRC reconfiguration that indicates or includes the cell group configuration of the second network entity 702b. The RRC reconfiguration may indicate or include a handover command, cell switch command, or the like. The first network entity 702a transmits, to the UE 704, an indication to handover to the second network entity 702b, such as the RRC reconfiguration.

At 726, the UE 704 may perform a random access procedure to establish communications with the second network entity 702b, such as a two-step random access procedure and/or a four-step random access procedure. As an example, the UE 704 may transmit, to the second network entity 702b, a random access preamble message via the cell served at or by the second network entity 702b.

At 728, the UE 704 transmits, to the second network entity 702b, an RRC reconfiguration complete message; and the second network entity 702b transmits the RRC reconfiguration complete message to the third network entity 702c. Accordingly the connection establishment between the UE 704 and the second network entity 702b is complete, and the UE 704 may communicate control plane traffic and/or user plane traffic with the third network entity 702c via the second network entity 702b.

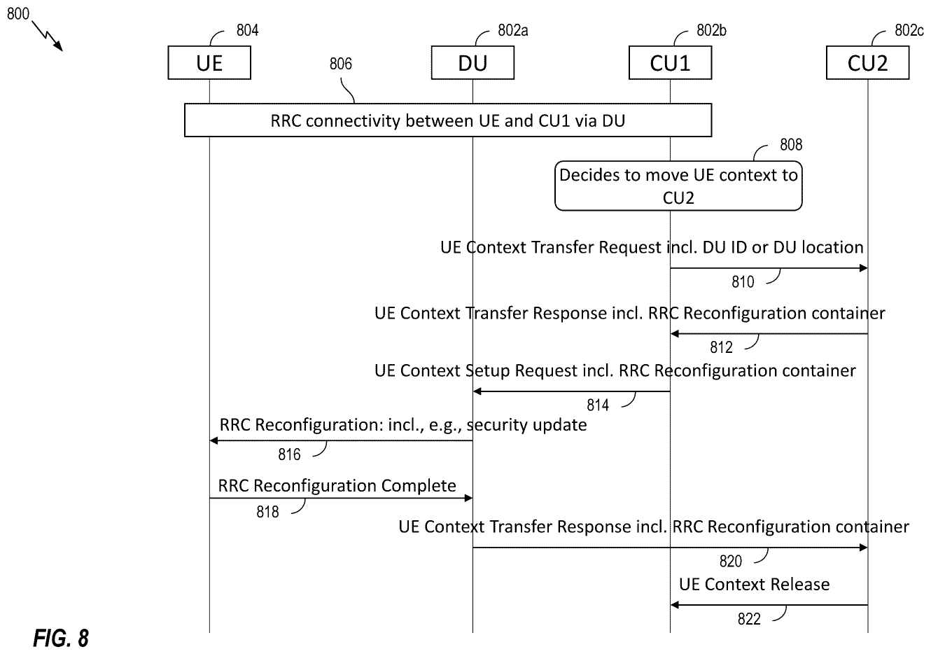

FIG. 8 depicts a process flow 800 for signaling related to inter-CU context transfer in a system including network entities 802a-c and a UE 804. In some aspects, any of the network entities 802a-c may be an example of the BS 102 depicted and described with respect to FIGS. 1 and 3 or a disaggregated base station (or one or more entities thereof) depicted and described with respect to FIG. 2. As an example, the first network entity 802a may be an example of a DU (depicted as “DU”), and each of the second network entity 802b and the third network entity 802c may be an example of a CU (depicted as “CU1” and “CU2”, respectively). Similarly, the UE 804 may be an example of UE 104 depicted and described with respect to FIGS. 1 and 3. However, in other aspects, UE 804 may be another type of wireless communications device and any of the network entities 802a-c may be another type of network entity or network node, such as those described herein. Note that any operations or signaling illustrated with dashed lines may indicate that that operation or signaling is an optional or alternative example.

At 806, the UE 804 establishes an RRC connection with the second network entity 802b via the first network entity 802a, for example, as described herein with respect to FIG. 6A.

At 808, the second network entity 802b may determine to transfer management of the user plane traffic session and/or control plane traffic session of the UE 804 to the third network entity 802c, for example, as described herein with respect to FIG. 6B. As an example, the second network entity 802b may decide to move the UE context of the UE 804 to the third network entity 802c based on the transport latency, traffic load, processing load, QoS specifications, and/or the like. As an example, the inter-CU context transfer may enable CU specialization, such as network slicing across multiple CUs. Accordingly, the inter-CU context transfer may enable reduced latencies, interruption times, and/or signaling overhead encountered during a cell switch or handover.

At 810, the second network entity 802b transmits, to the third network entity 802c, a UE context transfer request. The UE context transfer request may indicate or include the serving DU-ID, such as an identifier or address associated with the first network entity 802a (e.g., an identifier, location, address, name, or the like). The UE context transfer request may indicate or include the UE context (for example, for a Layer-3 handover preparation).

The UE context transfer request may indicate or include an indication that the serving DU (e.g., the first network entity 802a) can be used for communications between the UE 804 and the target CU (e.g., the third network entity 802c). As an example, the UE context transfer request may indicate or include an indication that the inter-CU context transfer occurs with an anchored DU (e.g., the first network entity 802a). The UE context transfer request may indicate or include serving cell(s) of the first network entity 802a used for communications with the UE 804.

At 812, the second network entity 802b obtains, from the third network entity 802c, a UE context transfer response. The UE context transfer response may indicate or include an RRC container with an RRC reconfiguration message for the UE 804. The RRC reconfiguration may indicate or include an updated security algorithm configuration for communications with the target CU (e.g., the third network entity 802c). The UE context transfer response may indicate or include a reconfiguration for the serving or anchored DU, such as the first network entity 802a. The UE context transfer response may indicate or include an identity of the target CU, such as the third network entity 802c.

At 814, the second network entity 802b transmits, to the first network entity 802a, a UE context setup request. The UE context setup request may indicate or include the RRC container with the RRC reconfiguration message. The UE context setup request may indicate or include an indication to forward communications between the UE 804 and the target CU, such as the third network entity 802c. The UE context setup request may indicate or include an identity of the target CU, such as the third network entity 802c. The UE context setup request may indicate or include the reconfiguration for the serving or anchored DU.

At 816, the first network entity 802a transmits, to the UE 804, an RRC reconfiguration, for example, in response to the UE context setup request obtained at 814. As an example, the RRC reconfiguration may indicate or include the updated security algorithm configuration for communications with the target CU (e.g., the third network entity 802c). The first network entity 802a may apply the reconfiguration obtained at 814. The first network entity 802a may reset at least a part of the Layer-2 protocol stack for the UE 804.

At 818, the UE 804 transmits, to the first network entity 802a, an RRC reconfiguration complete message. In certain aspects, the RRC reconfiguration complete message may indicate an acknowledgement of the security algorithm reconfiguration.

At 820, the first network entity 802a transmits, to the third network entity 802c, a UE context transfer response. The UE context transfer response may indicate or include the RRC reconfiguration complete message, and the first network entity 802a may forward the RRC reconfiguration complete message to the third network entity 802c based on the identity of the target CU obtained at 814.

At 822, the third network entity 802c transmits, to the second network entity 802b, an acknowledgement that the UE context of the UE 804 is successfully transferred. The acknowledgement may indicate or include a request to release the UE-related state, such as a request to release the UE context associated with the UE 804. Accordingly, the UE context transfer associated with the UE 804 is complete, and the UE 804 may communicate control plane traffic and/or user plane traffic with the third network entity 802c via the first network entity 702a.

FIG. 9 depicts another process flow 900 for signaling related to CU registration and CU selection in a system including network entities 902a-e and a UE 904. In some aspects, any of the network entities 902a-e may be an example of the BS 102 depicted and described with respect to FIGS. 1 and 3 or a disaggregated base station (or one or more entities thereof) depicted and described with respect to FIG. 2. As an example, each of the first network entity 902a and the second network entity 902b may be an example of a DU (depicted as “DU1” and “DU2”, respectively), and each of the third network entity 902c and the fourth network entity 902d may be an example of a CU (depicted as “CU1” and “CU2”, respectively). The fifth network entity 902e may be an example of a discovery service network entity (depicted as “Discovery Service”). Similarly, the UE 904 may be an example of UE 104 depicted and described with respect to FIGS. 1 and 3. However, in other aspects, UE 904 may be another type of wireless communications device and any of the network entities 902a-e may be another type of network entity or network node, such as those described herein. Note that any operations or signaling illustrated with dashed lines may indicate that that operation or signaling is an optional or alternative example.

At 906, each of the third network entity 902c and the fourth network entity 902d transmits, to the fifth network entity 902e, registration information associated with the respective network entity 902c, 902d. The registration information may indicate or include an association between an identifier associated with the respective network entity (e.g., a CU identifier (CU-ID)) and an address or location associated with the respective network entity. The address or location associated with the network entity may be or include an IP address, a domain name, a service type indicator, or the like. The CU registration may enable a DU to discover the location or address of the CU based on the CU-ID as described herein.

At 908, the UE 904 may perform a random access procedure to establish a communication link with the first network entity 902a. In certain cases, any of the random access messages communicated by the UE 904 may not include a CU-ID. As an example, MSG3 of a four-step random access procedure may be communicated without a CU-ID.

At 910, the first network entity 902a selects the CU to manage or serve the user plane traffic session and/or control plane traffic session of the UE 904. The first network entity 902a may select the CU based on one or more polices, such as an OAM configuration. As an example, the first network entity 902a may be configured to transmit RRC connection requests by default to a specific CU, such as the third network entity 902c.

At 912, the UE 904 establishes a communication link with the third network entity 902c via the first network entity 902a, for example, as described herein with respect to FIG. 6A.

At 914, the third network entity 902c may transfer the UE context of the UE 904 to the fourth network entity 902d without an inter-DU handover, for example, as described herein with respect to FIG. 8. As an example, the third network entity 902c may transfer the UE context of the UE 904 based at least in part on transport latency, load balancing, QoS specifications, or the like.

At 916, the fourth network entity 902d transmits, to the UE 904, an indication of the CU-ID for the fourth network entity 902d. As an example, the CU-ID may be communicated via an RRC connection release message. Notification of the CU-ID to the UE 904 may enable the UE 904 to request a communication link with a particular CU, such as the fourth network entity 902d.

At 918, the UE 904 may move within the coverage area of the second network entity 902b, for example, as described herein with respect to FIG. 5.

At 920, the UE 904 may perform a random access procedure to establish a communication link with the fourth network entity 902d. As an example, the UE 904 may transmit a random access message (e.g., MSG3) to the fourth network entity 902d via the second network entity 902b. The random access message may indicate or include the CU-ID of the fourth network entity 902d. In certain aspects, the random access message may include a request to establish a communication link with the fourth network entity 902d, such as an RRC connection setup request.

At 922, the second network entity 902b transmits, to the fifth network entity 902c, a request for the address or location of the fourth network entity 902d, for example, based on the CU-ID indicated or included in the RRC connection setup request.

At 924, the fifth network entity 902e transmits, to the second network entity 902b, an indication of the address or location of the fourth network entity 902d.

At 926, the second network entity 902b transmits, to the fourth network entity 902d at the discovered address, the RRC connection setup request from the UE 904.

At 928, the second network entity 902b forwards, from the fourth network entity 902d to the UE 904, an RRC connection complete message, to establish the communication link (e.g., a control plane traffic session and/or a user plane traffic session) with the UE 904. In some examples, the communications at 926, 928 may be associated with or part of an RRC establishment procedure 932.

At 930, the second network entity 902b forwards communications (e.g., control plane traffic and/or user plane traffic) associated with the communication link between the UE 904 and the fourth network entity 902d. Accordingly, the UE 904 may communicate control plane traffic and/or user plane traffic with the fourth network entity 902d via the second network entity 902b.

Note that the process flows illustrated in FIGS. 7-9 are examples of signaling that enable separation of inter-cell handover and context transfer, and aspects of the present disclosure may be applied to other mobility or handover operations, such as LTM, cell switch, and/or beam switch management. As an example, the signaling at 920-928 may be applicable for communications among another UE (e.g., the second UE 604b), the second network entity 902b, and the third network entity 902c, where the second network entity 902b may enable multiple UEs (e.g., the UEs 604a, 604b) to communicate with different CUs, as described herein with respect to FIG. 6A. Note that the process flow(s) illustrated in FIGS. 7-9 are described herein to facilitate an understanding of separation of inter-cell handover and context transfer, and aspects of the present disclosure may be performed in various manners via alternative or additional signaling and/or operations. In certain aspects, the operations and/or signaling of FIGS. 7-9 may occur in an order different from that described or depicted, and various actions, operations, and/or signaling may be added, omitted, or combined.

### Example Operations of Separation of Inter-Cell Handover and Context Transfer

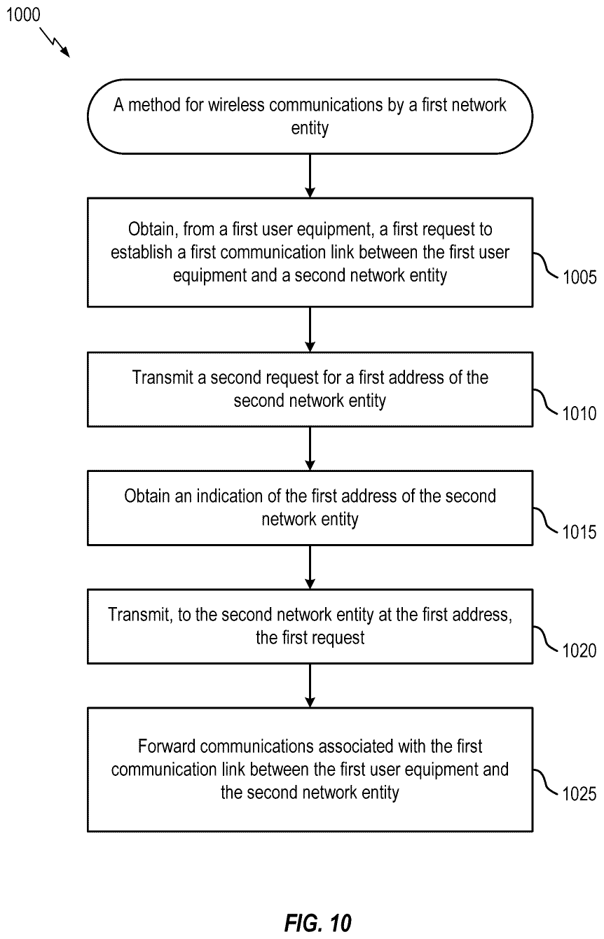

FIG. 10 shows a method 1000 for wireless communications by a first network entity, such as BS 102 of FIGS. 1 and 3, or a disaggregated base station as discussed with respect to FIG. 2. In certain aspects, the first network entity may be or include a DU, for example, as described herein with respect to FIGS. 6A and 6B.

Method 1000 begins at block 1005 with obtaining, from a first user equipment, a first request to establish a first communication link between the first user equipment and a second network entity, for example, as described herein with respect to FIGS. 6A and 9. In certain aspects, the first network entity includes a distributed unit (e.g., of a radio access network), and the second network entity includes a centralized unit (e.g., of the radio access network).

Method 1000 then proceeds to block 1010 with transmitting a second request for a first address of the second network entity, for example, as described herein with respect to FIGS. 6A and 9. Note that the use of “second” in “the second request” is intended to mean that “the second request” may be or include a separate message or communication with respect to the “the first request,” and so forth for any instances of “third request” and “fourth request.”

Method 1000 then proceeds to block 1015 with obtaining an indication of the first address of the second network entity, for example, as described herein with respect to FIGS. 6A and 9.

Method 1000 then proceeds to block 1020 with transmitting, to the second network entity at the first address, the first request, for example, as described herein with respect to FIGS. 6A and 9.

Method 1000 then proceeds to block 1025 with forwarding communications associated with the first communication link between the first user equipment and the second network entity. In certain aspects, block 1025 includes communicating with the first user equipment via a first cell. In certain aspects, the communications include one or more of user plane traffic or control plane traffic. In certain aspects, the communications include one or more of data radio bearer traffic or signaling radio bearer traffic.

In certain aspects, the first request includes an indication of the second network entity. In certain aspects, the indication of the second network entity includes an identifier associated with the second network entity, such as a CU-ID.

In certain aspects, method 1000 further includes transmitting, to a network entity discovery service, registration information associated with the first network entity. In certain aspects, the registration information comprises one or more of: an indication of one or more cell identifiers associated with one or more cells served by the first network entity; or an indication of a second address of the first network entity.

In certain aspects, block 1025 includes obtaining a random access message that includes the first request.

In certain aspects, the first request includes a radio resource control connection setup request.

In certain aspects, method 1000 further includes obtaining, from a second user equipment, a third request to establish a second communication link with a third network entity, for example, as described herein with respect to FIG. 6A. In certain aspects, method 1000 further includes transmitting, to the third network entity, the third request.

In certain aspects, method 1000 further includes forwarding communications between the second user equipment and the third network entity. In certain aspects, forwarding communications between the first user equipment and the second network entity comprises communicating with the first user equipment via a first cell; and forwarding communications between the second user equipment and the third network entity comprises communicating with the second user equipment via the first cell.

In certain aspects, the second network entity and the third network entity are part of a same public land mobile network (PLMN).

In certain aspects, method 1000 further includes transmitting, to the first user equipment, an indication of the second network entity, for example, as described herein with respect to FIGS. 6A and 9. In certain aspects, transmitting the indication of the second network entity comprises transmitting, to the first user equipment, the indication of the second network entity via one or more of radio resource control signaling, medium access control signaling, Layer-3 signaling, Layer-2 signaling, and/or the like.

In certain aspects, block 1025 includes communicating traffic with the second network entity via one or more of a point-to-point interface or a service-based interface associated with the second network entity. In certain aspects, the traffic includes radio resource control signaling.

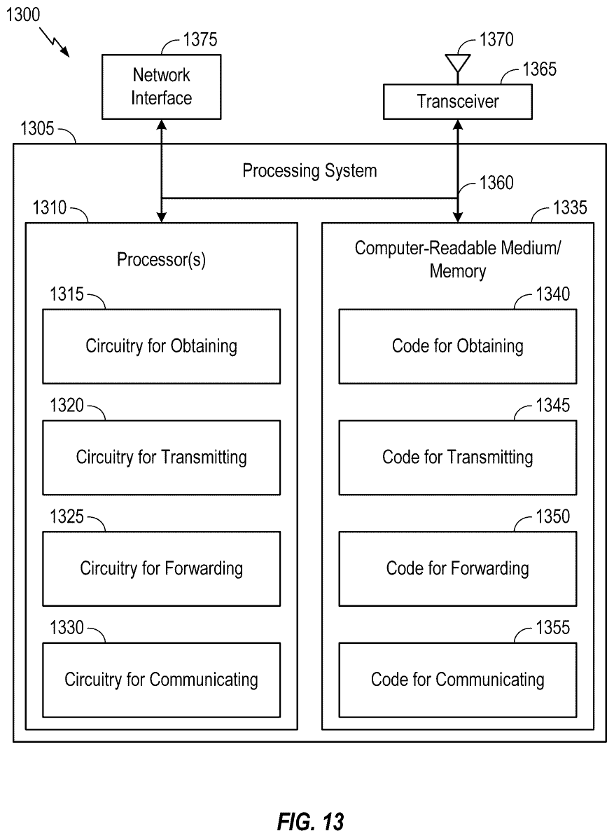

In certain aspects, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative operations are possible consistent with this disclosure.

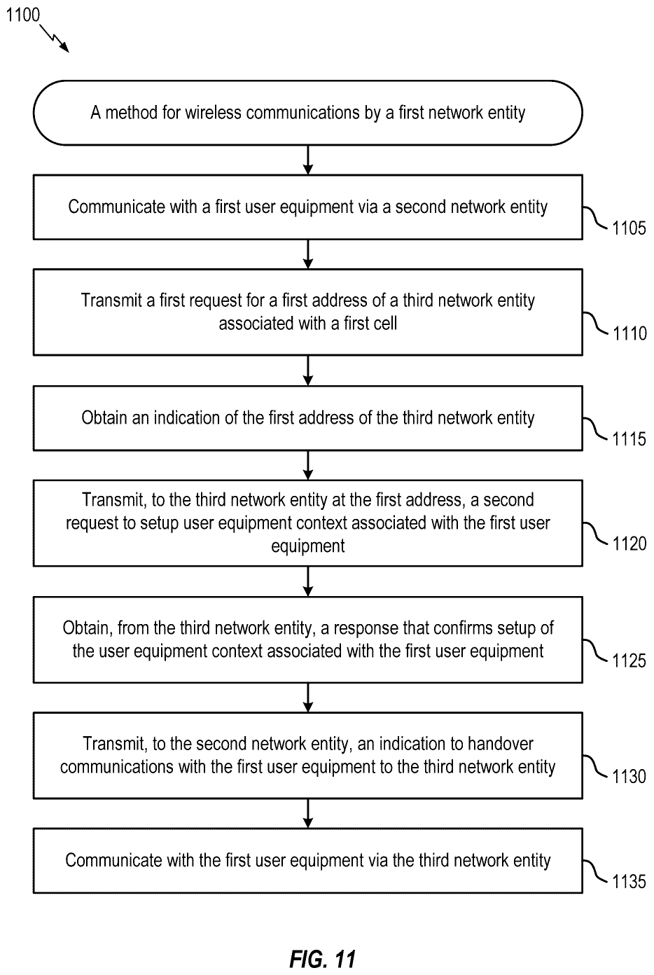

FIG. 11 shows a method 1100 for wireless communications by a first network entity, such as BS 102 of FIGS. 1 and 3, or a disaggregated base station as discussed with respect to FIG. 2. In certain aspects, the first network entity may be or include a CU, for example, as described herein with respect to FIGS. 6A and 6B.

Method 1100 begins at block 1105 with communicating with a first user equipment via a second network entity, for example, as described herein with respect to FIGS. 6A, 6B, and 7.

Method 1100 then proceeds to block 1110 with transmitting a first request for a first address of a third network entity associated with a first cell, for example, as described herein with respect to FIGS. 6A, 6B, and 7.

Method 1100 then proceeds to block 1115 with obtaining an indication of the first address of the third network entity, for example, as described herein with respect to FIGS. 6A, 6B, and 7.

Method 1100 then proceeds to block 1120 with transmitting, to the third network entity at the first address, a second request to setup user equipment context associated with the first user equipment, for example, as described herein with respect to FIGS. 6A, 6B, and 7.

Method 1100 then proceeds to block 1125 with obtaining, from the third network entity, a response that confirms setup of the user equipment context associated with the first user equipment, for example, as described herein with respect to FIGS. 6A, 6B, and 7.

Method 1100 then proceeds to block 1130 with transmitting, to the second network entity, an indication to handover communications with the first user equipment to the third network entity, for example, as described herein with respect to FIGS. 6A, 6B, and 7.

Method 1100 then proceeds to block 1135 with communicating with the first user equipment via the third network entity, for example, as described herein with respect to FIGS. 6A, 6B, and 7.

In certain aspects, method 1100 further includes obtaining, from the first user equipment via the second network entity, a measurement report that indicates one or more measurements associated with the first cell.

In certain aspects, block 1135 includes communicating with the first user equipment via a radio resource control connection.

In certain aspects, the first request includes a cell identifier associated with the first cell.

In certain aspects, the indication to handover communications includes a handover command with an indication of the first network entity.

In certain aspects, method 1100 further includes transmitting, to a fourth network entity, a third request to transfer user equipment context associated with the first user equipment, wherein the third request indicates to communicate with the first user equipment via the third network entity. In certain aspects, method 1100 further includes obtaining, from the fourth network entity, an acknowledgement of transfer of the user equipment context associated with the first user equipment. In certain aspects, the third request indicates a set of serving cells used for communication between the first user equipment and the third network entity. In certain aspects, the third request indicates the first address of the third network entity. In certain aspects, the acknowledgement includes a configuration for communications between the first user equipment and the fourth network entity. In certain aspects, the acknowledgement includes an identifier associated with the fourth network entity.

In certain aspects, method 1100 further includes transmitting, to the third network entity, a fourth request to transmit a radio resource control reconfiguration message to the first user equipment, wherein the fourth request indicates an identifier associated with the fourth network entity.

In certain aspects, the third request includes an indication of a fifth network entity that communicates user plane traffic with the first user equipment. In certain aspects, the fifth network entity includes a user plane centralized unit.

In certain aspects, method 1100 further includes transmitting, to the first user equipment via the second network entity or the third network entity, a radio resource control connection release message that indicates an identifier associated with of the first network entity.

In certain aspects, block 1105 includes communicating traffic between the second network entity and the first network entity via one or more of a point-to-point interface or a service-based interface associated with the second network entity. In certain aspects, the traffic includes radio resource control signaling.

In certain aspects, block 1110 includes transmitting the first request to a network entity discovery service.

In certain aspects, the first network entity includes a centralized unit; the second network entity includes a first distributed unit; and the third network entity include a second distributed unit.

In certain aspects, method 1100, or any aspect related to it, may be performed by an apparatus, such as communications device 1300 of FIG. 13, which includes various components operable, configured, or adapted to perform the method 1100.

Communications device 1300 is described below in further detail.

Note that FIG. 11 is just one example of a method, and other methods including fewer, additional, or alternative operations are possible consistent with this disclosure.

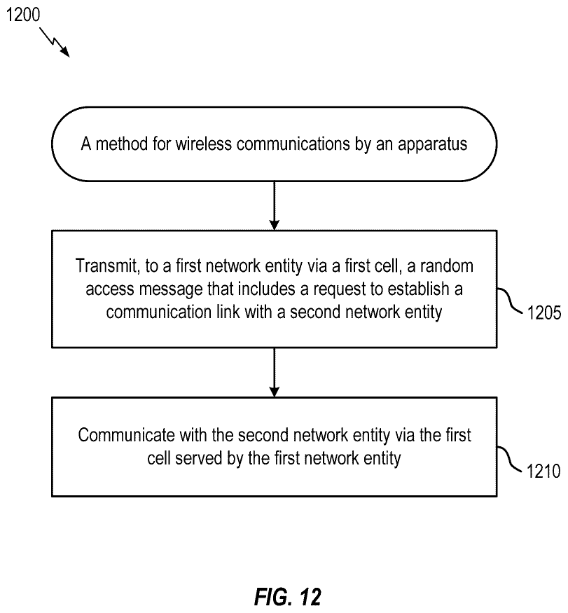

FIG. 12 shows a method 1200 for wireless communications by an apparatus, such as UE 104 of FIGS. 1 and 3.

Method 1200 begins at block 1205 with transmitting, to a first network entity via a first cell, a random access message that includes a request to establish a communication link with a second network entity, for example, as described herein with respect to FIGS. 6A and 9. In certain aspects, the first network entity includes a distributed unit, and the second network entity includes a centralized unit.

Method 1200 then proceeds to block 1210 with communicating with the second network entity via the first cell served by the first network entity, for example, as described herein with respect to FIGS. 6A and 9.

In certain aspects, the random access message includes an indication of the second network entity. In certain aspects, the indication of the second network entity includes an identifier associated with the second network entity, such as a CU-ID.

In certain aspects, the random access message includes a radio resource control connection setup request.

In certain aspects, method 1200 further includes obtaining an indication of the second network entity, for example, as described herein with respect to FIGS. 6A and 9. In certain aspects, the indication of the second network entity further indicates one or more of a time window or a geographic area for indication of the second network entity in the request to establish the communication link.

In certain aspects, obtaining the indication of the second network entity comprises obtaining, via the first network entity, a radio resource control message that includes the indication of the second network entity, for example, as described herein with respect to FIGS. 6A and 9.

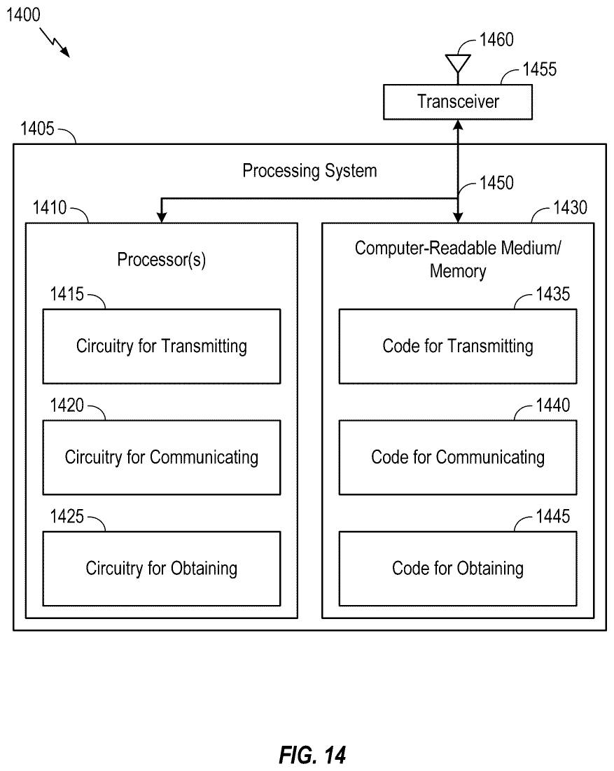

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and transmit signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code), including code 1340-1355, that when executed by the one or more processors 1310, enable and cause the one or more processors 1310 to perform the method 1000 described with respect to FIG. 10, or any aspect related to it, including any operations described in relation to FIG. 10; and the method 1100 described with respect to FIG. 11, or any aspect related to it, including any operations described in relation to FIG. 11. Note that reference to a processor of communications device 1300 performing a function may include one or more processors of communications device 1300 performing that function, such as in a distributed fashion.

In the depicted example, the computer-readable medium/memory 1335 stores code for obtaining 1340, code for transmitting (or sending) 1345, code for forwarding 1350, and code for communicating 1355. Processing of the code 1340-1355 may enable and cause the communications device 1300 to perform the method 1000 described with respect to FIG. 10, or any aspect related to it; and the method 1100 described with respect to FIG. 11, or any aspect related to it.

The one or more processors 1310 include circuitry configured to implement (e.g., execute) the code (e.g., executable instructions) stored in the computer-readable medium/memory 1335, including circuitry for obtaining 1315, circuitry for transmitting (or sending) 1320, circuitry for forwarding 1325, and circuitry for communicating 1330. Processing with circuitry 1315-1330 may enable and cause the communications device 1300 to perform the method 1000 described with respect to FIG. 10, or any aspect related to it; and the method 1100 described with respect to FIG. 11, or any aspect related to it.

Various components of the communications device 1300 may provide means for performing the method 1000 described with respect to FIG. 10, or any aspect related to it; and the method 1100 described with respect to FIG. 11, or any aspect related to it. Means for communicating, transmitting, sending, forwarding, or outputting for transmission may include the transceivers 332, antenna(s) 334, transmit processor 320, TX MIMO processor 330, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving, or obtaining may include the transceivers 332, antenna(s) 334, receive processor 338, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13.

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1455 (e.g., a transmitter and/or a receiver). The transceiver 1455 is configured to transmit and receive signals for the communications device 1400 via an antenna 1460, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code), including code 1435-1445, that when executed by the one or more processors 1410, enable and cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1430 stores code for transmitting (or sending) 1435, code for communicating 1440, and code for obtaining 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code (e.g., executable instructions) stored in the computer-readable medium/memory 1430, including circuitry for transmitting (or sending) 1415, circuitry for communicating 1420, and circuitry for obtaining 1425. Processing with circuitry 1415-1425 may enable and cause the communications device 1400 to perform the method 1200 described with respect to FIG. 12, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14. Means for communicating, receiving or obtaining may include the transceivers 354, antenna(s) 352, receive processor 358, AI processor 370, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by an apparatus comprising: obtaining, from a first user equipment, a first request to establish a first communication link between the first user equipment and a second network entity; transmitting a second request for a first address of the second network entity; obtaining an indication of the first address of the second network entity; transmitting, to the second network entity at the first address, the first request; and forwarding communications associated with the first communication link between the first user equipment and the second network entity.

Clause 2: The method of Clause 1, wherein the first request includes an indication of the second network entity.

Clause 3: The method of Clause 2, wherein the indication of the second network entity includes an identifier associated with the second network entity.

Clause 4: The method of any one of Clauses 1-3, wherein forwarding communications comprises communicating with the first user equipment via a first cell.

Clause 5: The method of any one of Clauses 1-4, further comprising transmitting, to a network entity discovery service, registration information associated with the first network entity.

Clause 6: The method of Clause 5, wherein the registration information comprises one or more of: an indication of one or more cell identifiers associated with one or more cells served by the first network entity; or an indication of a second address of the first network entity.

Clause 7: The method of any one of Clauses 1-6, wherein obtaining the first request comprises obtaining a random access message that includes the first request.

Clause 8: The method of any one of Clauses 1-7, wherein the first request includes a radio resource control connection setup request.

Clause 9: The method of any one of Clauses 1-8, further comprising: obtaining, from a second user equipment, a third request to establish a second communication link with a third network entity; transmitting, to the third network entity, the third request; and forwarding communications between the second user equipment and the third network entity.

Clause 10: The method of Clause 9, wherein: forwarding communications between the first user equipment and the second network entity comprises communicating with the first user equipment via a first cell; and forwarding communications between the second user equipment and the third network entity comprises communicating with the second user equipment via the first cell.

Clause 11: The method of Clause 9 or 10, wherein the second network entity and the third network entity are part of a same public land mobile network.

Clause 12: The method of any one of Clauses 1-11, further comprising transmitting, to the first user equipment, an indication of the second network entity.

Clause 13: The method of Clause 12, wherein transmitting the indication of the second network entity comprises transmitting, to the first user equipment, the indication of the second network entity via one or more of radio resource control signaling or medium access control signaling.

Clause 14: The method of any one of Clauses 1-13, wherein the communications include one or more of data radio bearer traffic or signaling radio bearer traffic.

Clause 15: The method of any one of Clauses 1-14, wherein forwarding communications comprises communicating traffic with the second network entity via one or more of a point-to-point interface or a service-based interface associated with the second network entity.

Clause 16: The method of Clause 15, wherein the traffic includes radio resource control signaling.

Clause 17: The method of any one of Clauses 1-16, wherein: the first network entity includes a distributed unit, and the second network entity includes a centralized unit.

Clause 18: A method for wireless communications by an apparatus comprising: communicating with a first user equipment via a second network entity; transmitting a first request for a first address of a third network entity associated with a first cell; obtaining an indication of the first address of the third network entity; transmitting, to the third network entity at the first address, a second request to setup user equipment context associated with the first user equipment; obtaining, from the third network entity, a response that confirms setup of the user equipment context associated with the first user equipment; transmitting, to the second network entity, an indication to handover communications with the first user equipment to the third network entity; and communicating with the first user equipment via the third network entity.

Clause 19: The method of Clause 18, further comprising obtaining, from the first user equipment via the second network entity, a measurement report that indicates one or more measurements associated with the first cell.

Clause 20: The method of any one of Clauses 18-19, wherein communicating with the first user equipment comprises communicating with the first user equipment via a radio resource control connection.

Clause 21: The method of any one of Clauses 18-20, wherein the first request includes a cell identifier associated with the first cell.

Clause 22: The method of any one of Clauses 18-21, wherein the indication to handover communications includes a handover command with an indication of the first network entity.

Clause 23: The method of any one of Clauses 18-22, further comprising: transmitting, to a fourth network entity, a third request to transfer user equipment context associated with the first user equipment, wherein the third request indicates to communicate with the first user equipment via the third network entity; and obtaining, from the fourth network entity, an acknowledgement of transfer of the user equipment context associated with the first user equipment.

Clause 24: The method of Clause 23, wherein the third request indicates a set of serving cells used for communication between the first user equipment and the third network entity.

Clause 25: The method of Clause 23 or 24, wherein the third request indicates the first address of the third network entity.

Clause 26: The method of any one of Clauses 23-25, wherein the acknowledgement includes a configuration for communications between the first user equipment and the fourth network entity.

Clause 27: The method of Clause 26, wherein the acknowledgement includes an identifier associated with the fourth network entity.

Clause 28: The method of any one of Clauses 23-27, wherein the one or more processors are configured to cause the first network entity to transmit, to the third network entity, a fourth request to transmit a radio resource control reconfiguration message to the first user equipment, wherein the fourth request indicates an identifier associated with the fourth network entity.

Clause 29: The method of any one of Clauses 23-28, wherein the third request includes an indication of a fifth network entity that communicates user plane traffic with the first user equipment.

Clause 30: The method of Clause 24, wherein the fifth network entity includes a user plane centralized unit.

Clause 31: The method of any one of Clauses 18-25, further comprising transmitting, to the first user equipment via the second network entity or the third network entity, a radio resource control connection release message that indicates an identifier associated with of the first network entity.

Clause 32: The method of any one of Clauses 18-26, wherein communicating with the first user equipment via the second network entity comprises communicating traffic between the second network entity and the first network entity via one or more of a point-to-point interface or a service-based interface associated with the second network entity.

Clause 33: The method of Clause 27, wherein the traffic includes radio resource control signaling.

Clause 34: The method of any one of Clauses 18-28, wherein transmitting the first request comprises transmitting the first request to a network entity discovery service.

Clause 35: The method of any one of Clauses 18-29, wherein: the first network entity includes a centralized unit; the second network entity includes a first distributed unit; and the third network entity include a second distributed unit.

Clause 36: A method for wireless communications by an apparatus comprising: transmitting, to a first network entity via a first cell, a random access message that includes a request to establish a communication link with a second network entity; and communicating with the second network entity via the first cell served by the first network entity.

Clause 37: The method of Clause 36, wherein the random access message includes an indication of the second network entity.

Clause 38: The method of Clause 37, wherein the indication of the second network entity includes an identifier associated with the second network entity.

Clause 39: The method of any one of Clauses 36-38, wherein the random access message includes a radio resource control connection setup request.

Clause 40: The method of any one of Clauses 36-39, further comprising obtaining an indication of the second network entity.

Clause 41: The method of Clause 40, wherein the indication of the second network entity further indicates one or more of a time window or a geographic area for indication of the second network entity in the request to establish the communication link.

Clause 42: The method of Clause 40 or 41, wherein obtaining the indication of the second network entity comprises obtaining, via the first network entity, a radio resource control message that includes the indication of the second network entity.

Clause 43: The method of any one of Clauses 36-42, wherein: the first network entity includes a distributed unit, and the second network entity includes a centralized unit.

Clause 44: One or more apparatuses, comprising: one or more memories comprising executable instructions; and one or more processors configured to execute the executable instructions and cause the one or more apparatuses to perform a method in accordance with any one of Clauses 1-43.

Clause 45: One or more apparatuses, comprising: one or more memories; and one or more processors, coupled to the one or more memories, configured to cause the one or more apparatuses to perform a method in accordance with any one of Clauses 1-43.

Clause 46: One or more apparatuses, comprising: one or more memories; and one or more processors, coupled to the one or more memories, configured to perform a method in accordance with any one of Clauses 1-43.

Clause 47: One or more apparatuses, comprising means for performing a method in accordance with any one of Clauses 1-43.

Clause 48: One or more non-transitory computer-readable media comprising executable instructions that, when executed by one or more processors of one or more apparatuses, cause the one or more apparatuses to perform a method in accordance with any one of Clauses 1-43.

Clause 49: One or more computer program products embodied on one or more computer-readable storage media comprising code for performing a method in accordance with any one of Clauses 1-43.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining or the like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A first network entity configured for wireless communications, comprising:
one or more memories; and
one or more processors coupled to the one or more memories, the one or more processors being configured to cause the first network entity to:
obtain, from a first user equipment, a first request to establish a first communication link between the first user equipment and a second network entity;
transmit a second request for a first address of the second network entity;
obtain an indication of the first address of the second network entity;
transmit, to the second network entity at the first address, the first request; and
forward communications associated with the first communication link between the first user equipment and the second network entity.

2. The first network entity of claim 1, wherein the first request includes an indication of the second network entity.

3. The first network entity of claim 2, wherein the indication of the second network entity includes an identifier associated with the second network entity.

4. The first network entity of claim 1, wherein to forward communications, the one or more processors are configured to cause the first network entity to communicate with the first user equipment via a first cell.

5. The first network entity of claim 1, wherein the one or more processors are configured to cause the first network entity to transmit, to a network entity discovery service, registration information associated with the first network entity.

6. The first network entity of claim 5, wherein the registration information comprises one or more of:
an indication of one or more cell identifiers associated with one or more cells served by the first network entity; or
an indication of a second address of the first network entity.

7. The first network entity of claim 1, wherein to obtain the first request, the one or more processors are configured to cause the first network entity to obtain a random access message that includes the first request.

8. The first network entity of claim 1, wherein the first request includes a radio resource control connection setup request.

9. The first network entity of claim 1, wherein the one or more processors are configured to cause the first network entity to:
obtain, from a second user equipment, a third request to establish a second communication link with a third network entity;
transmit, to the third network entity, the third request; and
forward communications between the second user equipment and the third network entity.

10. The first network entity of claim 9, wherein:
to forward communications between the first user equipment and the second network entity, the one or more processors are configured to cause the first network entity to communicate with the first user equipment via a first cell; and
to forward communications between the second user equipment and the third network entity, the one or more processors are configured to cause the first network entity to communicate with the second user equipment via the first cell.

11. The first network entity of claim 9, wherein the second network entity and the third network entity are part of a same public land mobile network.

12. The first network entity of claim 1, wherein the one or more processors are configured to cause the first network entity to transmit, to the first user equipment, an indication of the second network entity.

13. The first network entity of claim 12, wherein to transmit the indication of the second network entity, the one or more processors are configured to cause the first network entity to transmit, to the first user equipment, the indication of the second network entity via one or more of radio resource control signaling or medium access control signaling.

14. The first network entity of claim 1, wherein the communications include one or more of data radio bearer traffic or signaling radio bearer traffic.

15. The first network entity of claim 1, wherein to forward communications, the one or more processors are configured to cause the first network entity to communicate traffic with the second network entity via one or more of a point-to-point interface or a service-based interface associated with the second network entity.

16. The first network entity of claim 15, wherein the traffic includes radio resource control signaling.

17. The first network entity of claim 1, wherein:
the first network entity includes a distributed unit, and
the second network entity includes a centralized unit.

18. A first network entity configured for wireless communications, comprising:
one or more memories; and
one or more processors coupled to the one or more memories, the one or more processors being configured to cause the first network entity to:
communicate with a first user equipment via a second network entity;
transmit a first request for a first address of a third network entity associated with a first cell;
obtain an indication of the first address of the third network entity;
transmit, to the third network entity at the first address, a second request to setup user equipment context associated with the first user equipment;
obtain, from the third network entity, a response that confirms setup of the user equipment context associated with the first user equipment;
transmit, to the second network entity, an indication to handover communications with the first user equipment to the third network entity; and
communicate with the first user equipment via the third network entity.

19. The first network entity of claim 18, wherein the first request includes a cell identifier associated with the first cell.

20. An apparatus configured for wireless communications, comprising:
one or more memories; and
one or more processors coupled to the one or more memories, the one or more processors being configured to cause the apparatus to:
transmit, to a first network entity via a first cell, a random access message that includes a request to establish a communication link with a second network entity; and
communicate with the second network entity via the first cell served by the first network entity.
